(19) United States
(12) Patent Application Publication
(10) Pub. No.: US 2022/0117836 A1
(43) Pub. Date: Apr. 21, 2022

(54) ADJUSTABLE APPARATUS, SYSTEM, AND METHOD FOR CELLULAR RESTRUCTURING

(71) Applicants: Luke DERY, Brooklyn Park, MN (US); Gunnar LEIVSETH, Oslo (NO); Ole Jakob OLSEN, Stathelle (NO); Dale WAHLSTROM, Apple Valley, MN (US)

(72) Inventors: Luke DERY, Brooklyn Park, MN (US); Gunnar LEIVSETH, Oslo (NO); Ole Jakob OLSEN, Stathelle (NO); Dale WAHLSTROM, Apple Valley, MN (US)

(21) Appl. No.: 17/427,773

(22) PCT Filed: Feb. 1, 2020
(86) PCT No.: PCT/US20/16298

§ 371 Date: Aug. 2, 2021

Related U.S. Application Data
(60) Provisional application No. 62/800,234, filed on Feb. 1, 2019.

(51) Int. Cl. A61H 21/00; A61H 23/02

(52) U.S. Cl. CPC A61H 21/00; A61H 23/02; A61H 2201/5084; A61H 19/44; A61H 2201/0192; A61H 2201/5043; A61H 2201/1678; A61H 2201/5007

(57) ABSTRACT

An adjustable apparatus, system, and method for the regeneration of tissue by aligning a direction of therapy toward a tissue to be treated with mechanotherapy or mechanotransduction therapy.

### PRIORITY

This application claims priority to U.S. Provisional Patent Application Ser. No. 62/800,234, filed on Feb. 1, 2019, with the above application being incorporated herein by reference.

### BACKGROUND

The present invention relates to an adjustable apparatus, system, and method for cellular restructuring for the purpose of improving gross anatomical structures and their related functions.

Tissues of humans and animals are able to regenerate or repair themselves and thus enable stressed, injured, or damaged tissues, that cause underlying undesirable conditions such as incontinence, to repair themselves and thus eliminate the undesirable condition. The present invention utilizes energy transmissions such as low, medium or high vibrations or vibratory signals to create a regenerative or repair environment for tissues.

Regeneration or repair of tissue generally consists of three phases: inflammation, repair, and maturation. When a tissue is injured the cells are either quickly repaired or undergo necrosis (rupturing of the cell membrane and release of its intracellular contents). When there is an injury the body initiates or induces inflammation, which is required for the regeneration phase. Inflammation causes neutrophils and macrophages to arrive at the site of the injury. Neutrophils and macrophages are responsible for the phagocytosis of dead cell debris and for the production of the anti-inflammatory cytokines required for the down-regulation of the inflammatory response that prevents further damage.

The regulation of this inflammatory response has been described in many tissues, including skeletal muscle and is ultimately responsible for the passage from an injured tissue environment to one of tissue repair. During the tissue repair process the tissue cells go through maturation, which is the last phase of regeneration. Maturation results in the consolidation of differentiated cells that acquire a functionally mature phenotype. As one might suspect, the inflammation, differentiation and maturation phases differ from tissue to tissue.

The tissue repair process can be assisted by the application of an energy therapy such as mechanotherapy or mechanotransduction therapy. Mechanotransduction therapy applies vibrations to the tissue or cells of a particular tissue in order to cause a physical or chemical change in the tissue. The mechanical forces or stress imparted on the cells are converted by the cell into intra-cellular signaling and biochemical reactions that permit the cells of the tissue to repairs themselves.

As a mechanical stress is applied to the tissue, the cytoskeleton of the tissue cells increases in stiffness in response to the forces acting on different focal adhesion sites. The cell is able to transmit the force or stress, e.g. actomyosin or other myosin motors that may generate tension in the cytoskeleton. The fibrous scaffolds are then able to transmit the stress or tension over long distances.

The mechanical stress causes deformation of the nuclear envelope, and other stress sensing structures within cells and on the surrounding extracellular matrix (ECM). The cell then activates gene expression, produces new proteins and remodels the ECM that comprises its tissue microenvironment in a load-dependent manner. As the ECM microenvironment changes to repair the cell, the viscoelasticity properties of the tissue are repaired.

Any tissue may be treated by the present invention. One particular group of muscles that can be treated by the present invention is the pelvic floor muscles. The pelvic floor muscles are a mind-controlled and layered muscle group which surrounds the urethra, vagina, and rectum, and which, together with the sphincter muscles, functions to control these openings. This musculature also serves to support the urethra, bladder, and uterus, as well as to resist any increases in the abdominal pressure developed during physical exertion. The muscle group includes both longitudinal muscles and annular muscles.

Training of the pelvic floor musculature has proven efficient in preventing and treating several conditions, e.g. incontinence. Numerous exercises exist for training the pelvic floor musculature. For a number of reasons, the effect of these exercises varies among people. Also, it is known that mechanical vibrations in a range below approx. 120 Hz applied to the tissue increase the training effect of such exercises. As the musculature becomes stronger, it will be possible to measure the training effect by measuring the ability of the musculature to retract.

### Measuring Principle and Measurement Parameters

A stronger muscle can be expected to dampen an amplitude of oscillation applied thereto more than a weaker muscle. A first principle of measurement, therefore, may be to measure the amplitude dampening of an imposed oscillation. The measured amplitude can be described as A˜A₀ sin(wt). A relative amplitude dampening is defined as: where

ΔA=(A−Ao)/Ao (1)

A is the amplitude measured,
Ao is the amplitude imposed,
w is the angular frequency of the oscillation imposed, and
t is time.

It is considered well known to a person skilled in the art that the output signal from an accelerometer may represent an acceleration which can be integrated to obtain a velocity and a second time to obtain a displacement or deflection. It is also well known that accelerations, velocities, and displacements of equal magnitudes and opposite directions have average values of zero, and that meaningful parameters hence must be based on absolute values such as maximum acceleration, velocity, or amplitude, for example. In view of the above, it is clear that the dimensionless attenuation ΔA can be calculated from displacements in mm, velocities in m/s, accelerations in m/s2, and/or electrical signals input to the oscillator and output from the accelerometer. In any case, the attenuation ΔA can be expressed in dB, calibrated to display the force in Newton (N), etc. according to need and in manners known for persons skilled in the art.

During normal exercise, the volume of the muscle cells increases and the skeleton of the cells become more rigid. In another model, therefore, the pelvic floor musculature can be regarded as a visco-elastic material, i.e. as a material having properties between a fully elastic material and an entirely rigid and inelastic (viscous) material. For example, a slack or weak muscle can be expected to exhibit relatively “elastic” properties, whereas a tight or strong muscle can be expected produce more resistance and thus relatively “viscous” properties. Formally:
stress is the force acting to resist an imposed change divided by the area over which the force acts. Hence, stress is a pressure, and is measured in Pascal (Pa), and strain is the ratio between the change caused by the stress and the relaxed configuration of the object. Thus, strain is a dimensionless quantity.

The modulus of elasticity is defined as the ratio λ=stress/strain. The dynamic modulus is the same ratio when the stress arises from an imposed oscillation. When an oscillation is imposed in a purely elastic material, the elongation measured is in phase with the imposed oscillation, i.e. strain occurs simultaneously with the imposed oscillation. When the oscillation is imposed in a purely viscous material, the strain lags the stress by 90° (π/2 radians). Visco-elastic materials behave as a combination of a purely elastic and a purely viscous material. Hence, the strain lags the imposed oscillation by a phase difference between 0 and π/2. The above can be expressed through the following equations:

σ=σ₀ sin(ωt) (2)

ε=ε₀ sin(ωt−ϕ) (3)

λ=σ/ε (4)

where
σ is stress from an imposed oscillation (Pa)
ε is strain (dimensionless)
ω is the oscillator frequency (Hz)
t is time (s),
ϕ is the phase difference varying between 0 (purely elastic) and π/2 (purely viscous), and λ is the dynamic module.

Biomechanically, this may be interpreted as that a stronger muscle increases the force resisting the oscillation and thereby “delays” the vibrations measured by the accelerometer. This is equivalent with that a strong muscle is stiffer or “more viscous” than a slack, gelatinous, and “more elastic” muscle.

A general problem in the prior art in the field is that devices, methods, and systems fail to properly apply mechanotransduction therapy and then fail to properly and accurately record the therapy results. For example, patients present with various and unique anatomy. The vaginal canal, or instance, of patients or users can vary greatly due to genetics, injury, age and the like. Therefore, a therapy device or treatment for one patient or user may not necessarily be the best therapy device or treatment for another patient or user.

Another problem with the prior art is that measurement values are often given in terms of pressure, e.g. in millimeter water column. As pressure is a force divided by an area, the pressure reported will depend on the area of the measuring apparatus, and hence on the supplier. Therefore, in the literature in the field, measurement values are often given in the format ‘<Supplier_name> mmH20’, for example. In turn, this results in that measurement values from different apparatuses are not directly comparable, and consequently a need exists for supplier independent measurement values in the field of the invention.

U.S. Pat. No. 6,059,740 discloses an apparatus for testing and exercising pelvic floor musculature. The apparatus includes an elongate housing adapted for insertion into the pelvic floor aperture. The housing is divided longitudinally into two halves, and includes an oscillator as well as a cut out and equipment for measuring pressure applied to the housing halves from the pelvic floor musculature. The apparatus indicates the force pressing together the two halves in Newton (N), and essentially measures the training effect on muscles acting radially on the housing.

A need exists for an apparatus that may be adapted to various and unique anatomy so that therapy may be properly applied.

Another need exists that measures and trains the musculature running in parallel with a longitudinal direction of the apparatus or pelvic floor opening.

Still another need exists for an apparatus and therapy that may be directed or focused toward an anatomical defect in an effort to focus a therapy on a particular anatomical structure or location.

The object of the present invention is to address one or more of the above problems, while maintaining the advantages of prior art.

### SUMMARY OF THE INVENTION

According to the invention, tissue rehabilitation is achieved by an adjustable apparatus, system, and method for application of mechanotherapy or the transmission of energy to cause a strengthening, increasing of a tissue volume, or cellular restructuring of targeted muscles or tissues to be rehabilitated. Tissue rehabilitation can be accomplished by application of mechanical or electrical energy to tissues such as muscles or by transmission of energy to the central or autonomic nervous systems that in turn activate desired or targeted tissues.

The present invention includes a housing that is adaptable for a particular site or location of treatment. For instance, the housing may be generally curved or pliable to enable it to be applied to an arm or leg in order to treat the epidermis or skeletal muscle of a patient. The housing may be generally planar and/or pliable to permit it to be applied to a back, chest or abdomen of a patient in order to treat the back, chest, abdominal epidermis and skeletal muscles.

In another embodiment of the invention, the housing may be generally elongate and selectively adaptable or adjustable prior to or after inserting into an orifice or opening in a patient. Such openings include but are not limited to a pelvic floor opening to treat the pelvic floor muscles or tissue, rectal openings, urethral openings, and openings of the ears, nose and throat. Openings may also include surgical site openings. For instance, during the surgical treatment of internal organs such as the liver, lungs, bladder, kidneys, pancreas, heart, and brain. It is also contemplated that the device of the present invention may be implanted into and left permanently or temporarily within a patient.

The housing may include an adaptable or adjustable exterior that enables it to be selectively adjustable or expandable to engage or contact a tissue to be treated. In another example embodiment, the adjustable housing may cause continuity of tissue contact between various layers of tissues in proximity to each other in order to permit effective mechanotransduction therapy or mechanotherapy through the number of tissue layers. It is also contemplated herein to be able to transmit an effective amount of energy through an air gap between the housing of the device and any desired tissue to be treated.

The housing may include one or more mechanotherapy or mechanotransduction generators that are capable of creating a tissue regeneration response or environment in the selected or desired tissue to be rehabilitated. In one example embodiment, the mechanotherapy or mechanotransduction generator may include an energy generator and transmitter such as an oscillator that is capable of generating an energy, in the form of a vibration signal or mechanical pulse. An accelerometer can also be provided for reading the energy or vibration signals from the oscillator generator. The accelerometer may be connected to a signal processor configured for communicating signals representative of values read from the accelerometer. While vibration energy is discussed in detail herein, other types of energy and energy generators are also contemplated and should be considered to be within the spirit and scope of the invention.

The use of an accelerometer for measuring a response makes it possible to use a closed housing, simplify the remaining construction, and increase the accuracy of the measurements. It is also possible to calculate a relative amplitude attenuation, phase delay, and/or dynamic modulus in one or more dimensions. These parameters, combined or individually, can be used for characterizing the musculature in a more accurately and detailed manner than is possible with the prior art.

Also, imposing oscillations and/or measuring responses along several axes allow the adaptation of training and testing to specific muscle groups in the pelvis floor.

In another aspect, the present invention relates to a system using such an apparatus with a controller configured for controlling the frequency and/or amplitude of the oscillation. The system is characterized in that it further includes a control module configured for determining an oscillator parameter within at least one time interval, and for providing the oscillator parameter to the controller; a data capturing module configured for receiving a response from the accelerometer and calculating a result as a function of the oscillator parameter and the received response; an analysis module configured for calculating at least one group value based on a series of measurements of oscillator parameters and the results thereof; a data storage configured for storing and retrieving at least one data value from a group consisting of the oscillator parameters, response, calculated result, and group value; and communication means configured for conveying the data value between the modules and the data storage.

In a third aspect, the present invention relates to a method for using mechanotransduction to treat, testing, and exercise tissue, such as the pelvic floor musculature, wherein an oscillation is imposed on the musculature, characterized by measuring the response from the musculature using an accelerometer and characterizing the musculature based on the response to the oscillation imposed.

Suitable measurement parameters, such as the relative amplitude attenuation, phase delay, and/or dynamic modulus, may indicate, among other things, force and/or elasticity of various muscle groups in the pelvic floor.

In a preferred embodiment, the tissue or musculature is imposed an oscillation of a frequency equal or close to the maximum response frequency during training of the musculature. The maximum response frequency is assumed to change over time, and may be, inter alia, displayed and/or logged in order to document training effect, alone or in combination with one or more other parameters.

In another embodiment of the present invention, mechanotherapy or mechanotransduction therapy applied to the pelvic floor has been shown to foster tissue rehabilitation or a regenerative environment, and “jump-start” the proliferation and differentiation of stem cells for various types of tissues. In order for mechanotherapy or mechanotransduction to be the most effective, there must be enough tension in the pelvic floor to achieve sufficient mechanotherapy or mechanotransduction signaling. This tension may be achieved by voluntarily contracting the pelvic floor musculature. The tension can be further supplemented if using a barrier, similar to any of the embodiments disclosed herein, which provide a greater surface area for tissue compliance. In one embodiment of the invention, electrodes may be used to cause tissue pre-tensioning.

In an example embodiment of the present invention, the device is able to adjust or expand (manually or automatically) to determine an optimum pre-tension state of the targeted tissue. As the device expands it is able to read a measurement such as force, tissue viscosity, tension, device angle, and the like, to determine the optimal pre-tension state of the targeted tissue.

Additional features and embodiments include a housing that is rotatable about its long axis in an effort to direct or focus the therapy toward a particular anatomical location. Indicia may be applied or formed on the apparatus to assist in the instruction or use of therapy.

Additional features and embodiments will be apparent from the attached patent claims.

### BRIEF DESCRIPTION OF THE DRAWINGS

The invention will be described in more detail in the detailed description below with reference to the appended drawings, in which:

FIG. 1 is a longitudinal schematic section of an apparatus according to an embodiment of the invention;

FIG. 2 is a top view of an apparatus having at least one indicia for indicating a treatment application direction according to an embodiment of the invention;

FIG. 3A is a top view of an apparatus having indicia for aligning the apparatus with a particular anatomical location according to an embodiment of the invention;

FIG. 3B is an end view of an apparatus having indica indicating proper apparatus orientation according to an embodiment of the invention;

FIG. 3C is an end view of an adjustable apparatus having indica indicating a selectable parameter according to an embodiment of the invention; and

FIG. 3D is an end view of an adjustable apparatus having indicia indicating an angular orientation of a treatment focus according to an example embodiment of the invention;

FIG. 4 is a schematic depiction of the functions of the system;

FIG. 5 is a schematic illustration of a system according to the invention; and

FIG. 6 is illustrates a process of cellular restructuring according to an embodiment of the invention

### DETAILED DESCRIPTION

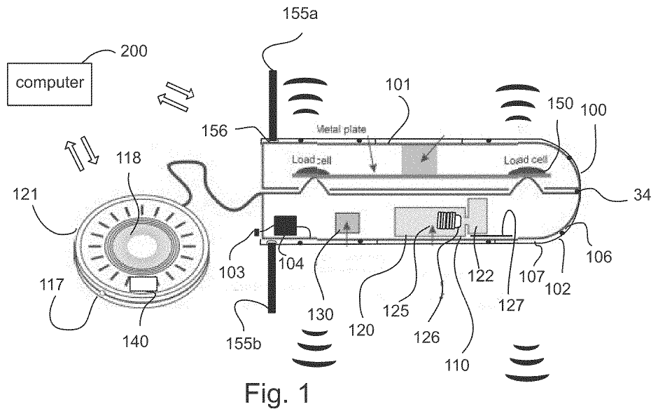

The present invention is directed to a device, system and method of rehabilitating a tissue. FIG. 1 illustrates a longitudinal schematic section of an apparatus 100 according to the invention. The apparatus 100 is comprised of an elongate, cylindrical housing 101, which can be made of a relatively rigid plastic material. Advantageously, an outer casing 102 made of medical silicone can be provided on the outside of housing 101. The size of the housing 101 is adapted for an opening in the pelvic floor.

In one embodiment of the invention, the housing 101, which may have the shape of a probe, has a diameter of 30 mm and a height or length of 100 mm. The diameter and the height or length of the housing 101 may be greater than or less than 30 mm and 100 mm respectively. In an example embodiment of the invention, the diameter and length of the housing 101 applies a predetermined or preferred pre-tension of the tissue being treated.

In an example embodiment of the invention, housing 101 may have a selectively adaptable or adjustable outer casing 102 that enables it to expand to engage or contact a tissue surface to be treated. The apparatus of FIG. 1 includes a port 103 for receiving a vibratory or energy transmission material or medium that is able to fill a void or gap between the outer casing 102 and the housing 101. The vibratory transmission material may comprise any material capable of permitting or aiding in the transmission of vibratory energy waves.

In one embodiment of the invention, the vibratory transmission medium may be inserted into the apparatus 100 by injection through the port 103.

The apparatus 100 may include a pump 104 and/or reservoir, not shown, that moves the vibratory transmission medium into and out of a portion of the housing 101. The pump 104 may be controlled by a pressure sensor that is capable of detecting a pressure exerted upon the vaginal wall or tissue being treated by the outer casing 102. Movement of the vibratory transmission medium moves the outer casing 102 between a resting state and an expanded state. The expanded state is generally characterized by having a deformed state such as a larger circumference and/or length than in the resting state.

Referring to FIG. 1, in one embodiment of the present invention, the pump 104 is operatively mounted inside the housing 101 and is in fluid communication with the outer casing 102. Operation of pump 104 causes the vibratory transmission medium to enter a space 106 between an inner surface of housing 101 and an inner surface of outer casing 102. When the outer casing 102 is in the expanded state it applies a force or stress on proximate tissue such that the tissue may be characterized as being in a pre-tension state. The importance of having a tissue in a pre-tension state will be discussed in more detail below.

The outer casing 102 may be expanded in a uniform manner or a generally non-uniform manner. A non-uniform expanded state permits the apparatus 100 to be used to treat specific or selective tissue areas. For instance, for a patient suffering from urinary incontinence, apparatus 100 may expand such that it is capable of pre-tensioning and treating an anterior of the vaginal wall. A patient suffering from urinary incontinence and fecal incontinence would benefit from pre-tensioning and treating the anterior and posterior vaginal walls. Apparatus 100 may include baffles 107 disposed in space 106 that are in fluid communication with pump 104 such that apparatus 100 may selective inflate certain baffles 107 or portions of the apparatus that causes pre-tensioning of selective tissue(s). Apparatus 100 may also include one or more valves in communication with pump 104 and baffles 107 to selectively control the baffles 107. The housing 101 or casing 102 can have a deformed shape that allows it to conform to the anatomical tissue to be targeted. For instance, it may take a saddle shape in the expanded state. The saddle shape allows the device to engage, pre-tension and transmits energy to the tissue engaged in urethral movement.

In one example embodiment of the invention, a generator 120 capable of generating energy in the form of vibrations, sounds waves, electricity and the like is housed in housing 101. For example, generator 120 may comprise an oscillator able to oscillate along one, two, or three axes, and an accelerometer 130 able to measure the acceleration along one, two, or three axes. Preferably, the axis or axes of the accelerometer 130 aligned with the oscillator axis or axes, for the following reason:

Assume that the oscillator effects an oscillation of the apparatus 100 along an axis x, and that the response is measured along an axis x′ forming an angle a with the x-axis. If a response along the x-axis is B, then the response along the x′-axis B′=B·cos α. B′ has a maximum for cos α=1, i.e. with α=0 and the x′-axis parallel with the x-axis. Correspondingly, B′=0 when the accelerometer axis is perpendicular to the oscillation (cos 90°=0). Thus, by arranging the x-axis of accelerometer 130 in parallel with the x-axis of oscillator we expect the largest possible signal and hence the greatest sensitivity possible. The same is true along the y- and/or z-axes when apparatus 100 has more than one axis. Also, the level of crosstalk between the measured signals is minimized when the axes are perpendicular to each other.

From FIG. 1 it can also be seen that generator 120 and accelerometer 130 are offset relative to each other along the longitudinal axis of the apparatus, i.e. the z-axis. Strictly speaking, therefore, they have separate axes in the x direction, e.g. x and x′. However, this has no significance as long as the axes are parallel to each other, cf. the previous section. Hence, for convenience, the x-axes of the oscillator, accelerometer and apparatus are referred to as one axis, “the x-axis”. The same applies for the y- and z-axes.

In a preferred embodiment, the frequencies of the generator (e.g., oscillations), and optionally also the amplitudes, can be controlled independently of each other along x, y, and z axes. This makes it possible to measure the strength of a muscle or muscle group running in parallel with the main axis of the apparatus, the z-axis, independently of muscles or muscle groups acting radially on the apparatus along a combination of the x- and y-axes of FIG. 1.

In the following, parameters of one, two, or three dimensions are denoted with boldfaced characters, and the component of a parameter along the x, y, and/or z axis is indexed with x, y, and z, respectively. For example, the frequency ω=(ωx, ωy, ωz). In some embodiments, the three frequency components may have different values, and one or two of the components can be zero, i.e. one or two oscillators could be eliminated. The same applies for a response or out signal a from accelerometer 130, calculated results ΔA, ϕ.A, and so on. Components along the x, y, and z axes are measured and calculated independently of each other, e.g. as indicated in eqs. (1) to (4).

The generator 120 can be controlled to create energy waves or vibrations with a specific frequency, preferably within the range of 15-120 Hz, by a power supply 110. Alternatively, the generator 120 can be driven by an alternative power source such as a battery. Other wave characteristics can be altered, such as amplitude, to provide varying therapy parameters.

The output signal from accelerometer 130 can be passed to a controller 121 that is adapted to control various features and functions of the apparatus 100. The controller 121 may contain a signal processor 140 capable of processing data received by the apparatus 100. In embodiment of the invention, the data may be sent to a computer 200. Alternatively, the entire or parts of the signal and data processing can be performed by a unit inside the housing 101 or computer 200.

In some applications, accelerometer 130 and/or signal processor 140 may be driven by electric power supplied through a USB connection, for example. In other applications, it may be necessary or convenient to have a separate grid-connected transformer in the power supply 110.

FIG. 1 further illustrates the principle of a possible generator 120 comprising an oscillator. The oscillator may include a permanent magnet 126 arranged in a coil 125. When an AC voltage Vx is applied to the poles and a current is driven through the coil, a variable magnetic field is induced which drives the permanent magnet 126 back and forth in a reciprocating motion. The permanent magnet 126 is attached to a weight 122 which hence also moves back and forth. When the oscillator is attached to housing 101, the apparatus 100 will oscillate along the x-axis.

FIG. 1 also illustrates a contact member 127 operatively positioned in the interior of the housing 101. The contact member 127 is adapted to be selectively struck or contacted by the weight 122 as it is rotated by the generator 120. The contact member 127 may comprise a sheet of rigid material such as metal connected to or positioned in an interior portion of the housing 101. However, other rigid or semi-rigged materials may also be employed. If additional energy is required, a user may use the controller 121 to select that the weight 122 engage or strike the contact member 127. By striking the contact member increased energy waves are produced.

The accelerometer 130 may comprise any type of accelerometer including a piezoelectric disc or bar fixedly clamped within a housing. The disc retains a seismic mass. When the housing is moved back and forth along the x-axis, the disc will be acted on by the mass and an electric charge is produced, typically a few pC/g, on the disc by the piezoelectric effect. For frequencies below about one third of the resonance frequency of the accelerometer housing, this charge will be proportional with the acceleration. Commercial vibrational testing accelerometers of this type typically have a frequency range from approx. 0.1 to above 4 kHz, i.e. far outside the range of 15-120 Hz preferred in the present invention. A schematic of an accelerometer that is capable of being used is disclosed in U.S. Patent Application No. 62/597,934, the entirety of which is incorporated herein by reference. The present invention may be used with any type of oscillator or accelerometer. U.S. patent application Ser. No. 15/618,104 is also incorporated herein in its entirety by reference. U.S. Pat. No. 9,949,888 is also incorporated herein in its entirety by reference.

The computer 200 can be of any design. Suitable computers have a programmable processor, and include personal computers, portable units (PDAs), etc. Computer 200 can be connected to a display, printer, and/or data storage in a known manner for displaying and/or logging measurement results.

Signals from an accelerometer 130 of apparatus 100 are amplified and/or processed in a signal processor 140, and transferred to computer 200 for analysis and/or logging. The connection between apparatus 100 and the processor 140 may include several channels for controlling oscillators along several axes independently of each other as well as for measuring responses of a uniaxial or multiaxial accelerometer. The same applies for the connection between the processor 140 and computer 200. This connection may be a USB (3.0, 2.0 or the like) connection, and, in some applications, electric power may be supplied from the computer through the USB connection.

In some embodiments, signals may be transferred wirelessly, e.g. by way of radio signals, infrared light, or ultrasonic signals.

Signal processor 140 may also include: a CPU including the appropriate software; electronic circuitry programmed with suitable algorithms for managing and controlling the oscillation frequency and optionally the oscillation amplitude; input(s) for at least one EMG sensor (EMG=Electromyography); and input(s) for at least one force sensor.

In another example embodiment of the invention, one or more sensors 150 such as load cells may be operatively connected in or to a portion of the housing 101. In one embodiment, the sensors 150 are positioned in the interior of the housing 101 and in operative communication with one or more of the housing 101, vibratory transmission medium 106, internal housing pressure, and the like.

In yet another embodiment of the invention, the apparatus 100 may include one or more orientation members 155a and/or 155b extending away from a generally proximal end of housing 101. The orientation members 155a and/or 155b may be used to identify an anterior or posterior of the housing 101. In addition, orientation members 155a and/or 155b may be grasped by a user during use of the apparatus 100. The orientation members 155a and/or 155b may be manufactured from the same or similar material as the outer casing 106.

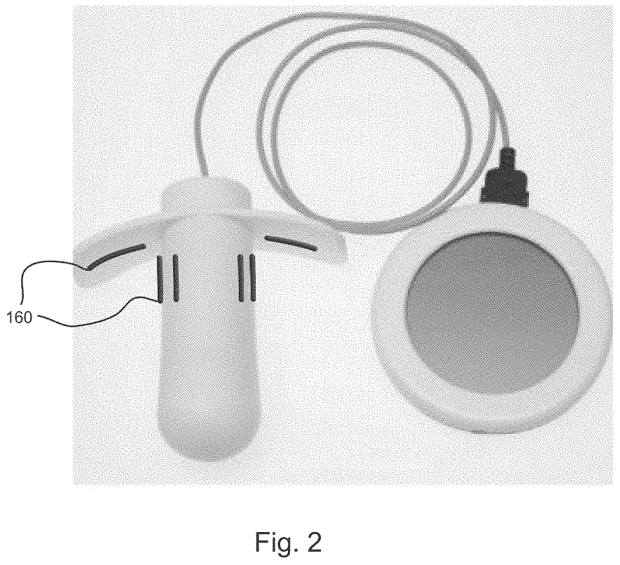

As illustrated in FIG. 2, an outer surface of the outer casing 102 and a portion of the orientation members 155a and/or 155b may include one or more indicia 160. The indicia 160 may be made from a coloring agent or material being added to the casing 102 or orientation members 155a and/or 155b material. In another embodiment of the invention, the indicia 160 may have a three dimensional shape such as a rib, bump, and the like. Other means of identifying a position or orientation of the apparatus 100 or a portion thereof are also contemplated herein and the foregoing should not be considered limiting.

The indicia 160 may be used to identify or indicate a focal point of energy transmission. Additional indicia 160 may be spaced apart and used to identify varying degrees or strength of energy transmission. For instance, indicia on the housing 101 or casing 102 that is aligned with indicia on one or more of the orientation members 155a or 155b can indicate a focal point of energy transmission. Indicia spaced at 30, 45, or 90 degrees from an initial indicia on one or more of the orientation members 155a or 155b can indicate an energy transmission that is half, a third, or a quarter the energy transmission at the focal point. Any degrees and any reduction of energy transmission are possible and should be considered to be within the spirit and scope of the invention.

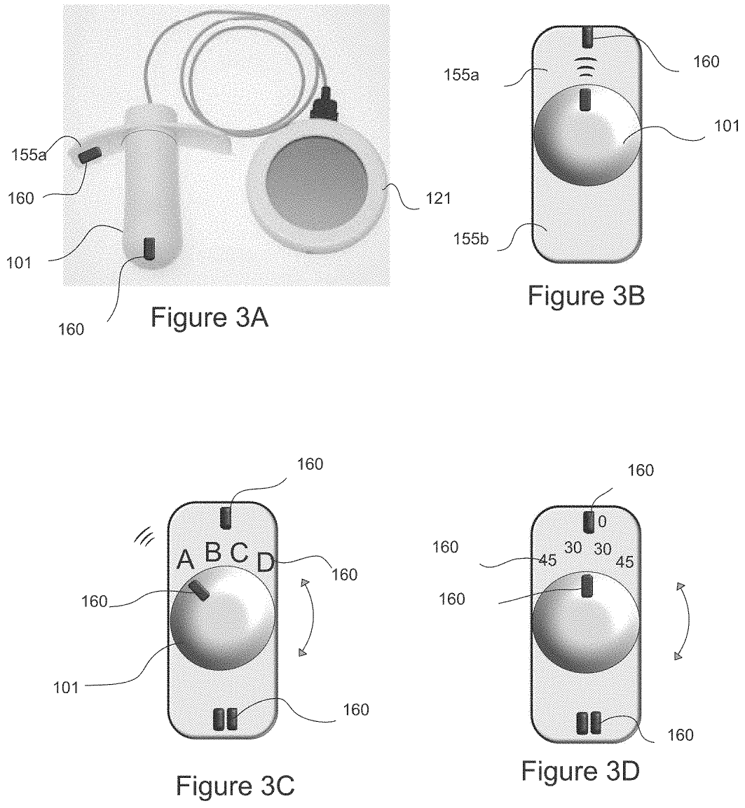

In another embodiment of the invention, as illustrated in FIGS. 3A-3D, the housing 101 of the apparatus 100 is rotatable with respect to the orientation members 155a and 155b. Referring back to FIG. 1, the orientation members 155a and 155b may be a unitary piece and have an opening extending there through that defines an annular lip. The annular lip can be set into a circumferential channel 156 within the outer casing 102 and/or housing 101. The channel 156 may have one or more spaced apart detents extending about it and formed therein that engage a mating structure in the annular lip of the orientation members 155a and 155b. The detents ensure precise movement and placement of the housing 101 with respect to the indicia 160 on the orientation members 155a and 155b.

Referring to FIG. 3B, during use, the indicia 160 on the orientation member 155a can be aligned with a user's clitoris or other anatomical feature. When the indicia 160 on the housing 101 and the indicia 160 on the orientation member 155a are aligned along a longitudinal axis of the orientation member 155a, it indicates that the highest intensity of the energy is aligned with the midline of the anterior of the patient or user.

Referring now to FIG. 3B, if a user rotates the housing 101 with respect to the orientation members 155a and 155b, the user is able to direct the highest intensity of the energy toward a particular area of their anatomy. The apparatus 100 may include any indicia on the orientation members 155a and 155b to assist a clinician in the instruction given to a user to in locating and focusing the highest energy intensity to an affected area to be rehabilitated.

The ability to focus the highest energy transmission improves the ability to target and rehabilitate particular pelvic floor defects. For instance, if a user or patient has a tear or other defect in their levator ani muscle, the user is able to focus the energy to the side or location of the defect. If there are multiple defects, a patient or user is able to move or rotate the housing 101 during a therapy session to treat the different defects.

As illustrated in FIGS. 3C and 3D, the indicia 160 on the orientation members 155a and 155b may be numbers, letters, and the like. Having different indicia enables a clinician to instruct a patient or user to rotate the housing 101 to a letter or number first and then to a second letter or number.

The orientation members 155a and 155b themselves may also have different indicia 160. For instance, orientation members 155a may have a single indicia while the orientation member 155b may have more than one indicia. The variation in the indicia between the orientation members 155a and 155b enables a clinician to instruct patients or users how to focus the energy toward a posterior muscle group. The ability to rotate the housing 101 toward the posterior of a patient or user permits the apparatus 101 to also be used to treat and rehabilitate fecal incontinence and other rectal defects.

The controller 121 and/or apparatus 100 may be charged by a power cord or a replaceable power source such as batteries. A USB plug or adapter may be mated to the controller 121 or apparatus 100 to charge the power source. In another embodiment of the invention, the controller 121 and/or apparatus 100 may be charged by inductive charging. A charging station, not shown, may receive the controller 121 or apparatus. Additionally to the charge input, or in an alternative embodiment, in which the battery or batteries or the battery package is to be replaced or charged at another location, the controller 121 may include a cover that can be opened and closed, or the casing (housing) of the unit or one half of the unit may be arranged so as to be easily opened and closed (i.e. without the need for using a tool).

Signal processor 140 may further include a loudspeaker and/or display 118 for the instantaneous or immediate biofeedback on muscle activation as observed through the dampening of energy waves such as oscillations and/or force read from the apparatus 100. The display 118 may also display EMG activity in the muscle acting on apparatus 100. Display 118 may have a suitable shape adapted for the requirements of functionality and placement. In an example embodiment, an octagonal (eight-sided), six-sided or round LCD or LED display 118, having about 40 segments, for example, could be used. The controller 121 may also include an on/off button 117. In addition, or alternatively, the electronic circuitry of signal processor 140 may be configured so as to switch off after a predetermined time interval of inactivity, e.g. from one to a few minutes of no active use.

Additionally, the controller 121 may include a CPU device and/or calibration means including at least one of a CPU device and various sensor means to allow, among other things, the calibration of a new apparatus 100 in the system. The controller 121 may also transfer, e.g. wirelessly, real-time data to from the processor 140 to the computer 200 of various reasons.

Apparatus 100 may include an integrated triaxial gyro sensor which, together with the triaxial accelerometer 130, allows the data or signal processor 140 or computer 200 to calculate the 3D orientation of the apparatus 100.

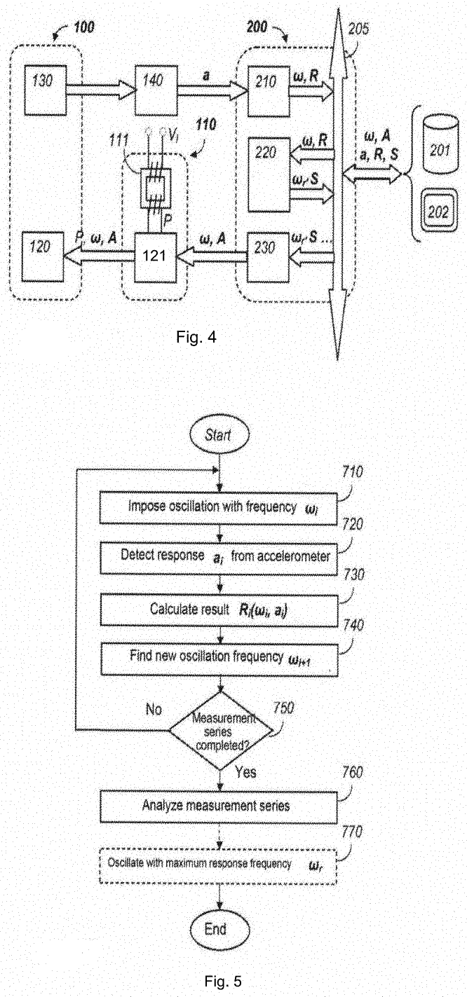

In one embodiment of the invention, as illustrated in FIG. 4 hardware and software in the computer 200, determines an oscillator parameter, i.e. frequency and/or amplitude, for the energy waves created by the generator 120. When the apparatus 100 is being used for the first time, the control module 230 in the computer 200 could set the frequency ω to a fixed initial value and then increase the frequency in predetermined increments Δω. On subsequent use, control module can use previous results for selecting other initial values and/or frequency intervals. This is described in more detail below. The same applies for the amplitude settings. Alternatively, oscillator parameters could be determined in a binary search which is ended when the values of two consecutively calculated values are closer than a predetermined resolution, e.g. Δωx=5 Hz.

Both frequency and amplitude may be adjusted along the x, y, and z axes independently of each other by means of controller 121. The controller 121 is connected to a power source in the form of a transformer 111 connected to a grid voltage V1, delivering a power P with the desired current and voltage. For example, the controller 121 may control the amplitude Ax and frequency ωx of the oscillator by controlling the current, voltage, and frequency of the signal supplied at the poles Vx, and in a similar manner for oscillators oscillating along the y and/or z axes.

The oscillation is imposed on tissue surrounding apparatus 100, and the response is measured by accelerometer 130.

Signals from accelerometer 130 of apparatus 100 are passed to a signal processor 140, which may be contained within the controller 121.

Accelerometer 130 may include a preamplifier. Other configurations are possible as well. The output signal from signal processor 140 is shown as a, and may represent, for example, acceleration along the x, y, and/or z axes at a measurement point at which the imposed oscillation was ωi.

A data capturing module 210 process the signal further, and may, for example, integrate an acceleration to obtain a velocity and once more to obtain a displacement, measure a phase difference, etc. Said integration of acceleration, measurement of phase difference, etc. may be carried out at several locations in the signal path using feedback operational amplifiers, firmware, and/or software, for example, in a known manner. Note that the signal path of FIG. 2 is exemplary only.

Output data from the data capturing module 210 are shown schematically as a measurement point ω, R, at which a result R is measured or calculated at an applied frequency ω. The result R may represent one or more of: acceleration a, velocity, displacement, relative amplitude attenuation ΔA, phase shift, stress, strain, and/or dynamic modulus as discussed above. In some applications, the oscillator amplitude may also be varied. Advantageously, the data capturing module can store a measurement sequence including a series of measurement points each representative of an oscillator parameter ω or A and a measured or calculated result R. As used herein and in the claims, the term “data values” is understood to mean any parameter value and/or the components thereof along the x, y, and/or z axes.

A data bus 205 carries data values between various components and modules of computer 200. For example, a measurement series with a sequence of measurement points (ωi, R;) can be temporarily be stored in a data storage 201 before the measurement series is further processed in an analysis module 220. In another embodiment, the measurement points (ωi, R;) could be passed to analysis module 220 at a later point, and the processing results, represented by (ωr, S), could be stored in data storage 201 and/or displayed on a display means 202.

Analysis module 220 is a module processing one or more measurement series to characterize the musculature and the development thereof using one or more parameters deemed suitable.

In a preferred embodiment, a maximum response frequency on is obtained for each measurement series. The maximum response frequency on is the value of the imposed frequency for which the measurement parameter selected indicated a maximum response from the tissue surrounding the apparatus, such as the maximum amplitude attenuation, minimum amplitude measured, largest dynamic modulus, etc. This is discussed in more detail below.

In principle, analysis module 220 may calculate any desired group value and/or carry out statistical analysis of the acquired data, such as statistical distributions, mean or expected value, variance, maximum values, and trends in the development of the measured and calculated results described above, for example.

In one embodiment, for example, the group value S may represent a subinterval of the range of 15-120 Hz within which the maximum response frequency ωr is located with a given probability. This interval may be calculated as a confidence interval from earlier measurement series using known statistical methods, and is expected to become smaller as the number of measurement series increases and the variance hence reduces. The purpose of calculating such a subinterval is to avoid superfluous measurements.

An exemplary trend analysis is the development of the maximum response frequency ωr over a few days or weeks, which may provide information on training effect.

The invention can include wireless technology (such as wifi, Bluetooth and the like) that enables it to transfer data generated or obtained by the invention to other devices such as smart phones, pads, computers, printers, and the like. Similarly, the other devices can be used to control the operation of invention. One of the advantages of the wireless technology is that it enables a patient to work with healthcare professional that are remotely located. This is particularly advantageous to patients that live in remote areas. A patient may also be able to purchase the invention from a retailer and then, while in the comfort of their home, work with a healthcare professional that is located remotely.

Prior to application of the treatment, the probe or housing 101 can be inserted into the vaginal opening for the purpose of pre-tensioning the targeted tissue. The device is able to, either manually or automatically, move between a resting state and an expanded state to move the tissue to a pre-tension state. The device is able to determine an optimal pre-tension state of the tissue by various means, including but not limited to an amount of force applied to the tissue, a viscoelasticity of the tissue, an angle or angle of movement of the device during a contraction, impedance and the like. Other parameters may also be determined and should be considered to be within the spirit and scope of the invention. The cycle of determining the optimum pre-tension state can be run a number of times to obtain an optimal average of pre-tension.

Referring to FIG. 5, in block 710, the musculature is imposed a first energy transmission such as an oscillation represented by (or. In practice, this can be accomplished by introducing an apparatus as described above into a pelvic floor aperture and supply the oscillator of controller 120 with electric power. The oscillation may be imposed along one or more mutually orthogonal axes (x, y, z). At the first use, the initial value could be about 15 Hz, for example, along each axis. After the apparatus has been used one or more times the initial values may be based on previous results and analyses.

In block 720, the response ai, from the tissue or musculature is measured by means of an accelerometer 130 having axes oriented in parallel with the oscillator axes x, y, and/or z.

Block 730 illustrates that a result Ri is found from an imposed oscillation ωi and its response a; as measured in a predetermined time interval. The measurement point (ωi, Ri) may be part of a measurement series in which i=1, 2, . . . n, and each index i represents a separate time interval. Both the imposed frequency and the measured or calculated result have distinct values along the oscillator axes. Results suitable for characterizing the musculature may be the relative amplitude attenuation ΔA, dynamic modulus λ, and/or phase shift ϕ between the applied and measured signals. The values may be measured and/or calculated as set out above in connection with eqs. (1) to (4), and independently of each other along the axis or axes x, y, and/or z. The measurement point (ωi, Ri) can be stored or logged as part of this step.

In block 740 an oscillation frequency for the next measurement point is calculated, and in determination block 750 a determination is made whether the measurement series has been completed.

In a first embodiment of the method, the imposed frequency is incrementally increased in block 740, for example according to ωi=ω0+i. Δω, where Δω denotes a desired resolution for the measurement series, such as 1 Hz or 5 Hz. In this case, the loop ends in determination block 750 when the new frequency Δωi+1 exceeds a predetermined threshold, e.g. 120 Hz, along the axis or axes.

In an alternative embodiment of the method, the objective is to find a maximum response using the smallest number of measurements possible. This may be carried out efficiently by way of a binary search. For example, assume that the result R from block 730 increases with the response of the musculature to the imposed oscillations, that a first interval is 15 Hz to 120 Hz, and that the desired resolution is 5 Hz along each axis. In this case, the binary search can be performed by bisecting the interval, rounding the frequency down to the nearest integer frequency divisible with the resolution, and compare the results of block 730 for each of the two frequencies in the upper and lower parts of the interval, e.g. R1 at ω1=15 Hz and R2 at ω2=50 Hz. If R2>R1, ω3 is selected as the center of the interval 50-120 Hz in block 740, otherwise ω3 is selected as the center of the interval 15-50 Hz in block 740. Similar bisection of the intervals is repeated in this alternative embodiment until determination block 750 indicates that the next interval is narrower than the desired resolution, e.g. 5 Hz along each axis.

If the responses along the axes are independent of each other, a binary search in the interval 15-120 Hz with a resolution of 5 Hz along each axis will be able to find an approximate maximum response frequency using at most 6 measurement points, whereas a sequential search in the interval 15-120 Hz with a resolution of 5 Hz would require 21 measurement points.

If determination block 750 indicates that the measurement series has not been completed, a new iteration is performed in which block 710 imposes an oscillation with a new frequency Δωi+1, etc. When determination block 750 indicates that the measurement series has been completed, the process proceeds to block 760.

In block 760 one or more measurement series is analyzed as described for analysis module 220 above. In a preferred embodiment, the maximum response frequency ωr is calculated for each measurement series. By definition, this is the frequency at which the musculature responds most strongly to the imposed oscillation. In practice, the maximum response frequency can be rounded down to the nearest integer frequency which is divisible with the resolution, i.e.

ωᵣ=Δω·round(ωᵣ′lΔω)), (5) where
ωᵣ is the practical value of the maximum response frequency,
ωᵣ′ is the theoretical or ideal value of the maximum response frequency,
Δω. is the resolution chosen, e.g. 5 Hz as in the above example, and round( ) is a function which rounds down to the nearest integer.

Block 770 has been drawn with dashed lines to illustrate that the method may, but does not necessarily, include controlling the oscillator to impose the practical value for the maximum response frequency while a user performs pelvic floor exercises as described in the introductory section. Hence, in a preferred embodiment, the resolution Δω should be selected so that the difference between the practical and actual values is of little or no significance. For example, if it turns out to be a telling difference between training with an imposed oscillation of 62 Hz as compared to 60 Hz, Δω in the above example should be reduced from 5 Hz to 1 Hz.

The method may further include storing and/or displaying one or more oscillation parameters, measurement values, calculated results, and/or group values. Each data value may be stored in a data storage 201 and displayed on a monitor 202. It is also possible to log parameters by printing them on paper. Hence, a printer (not shown) may optionally be used instead of or in addition to data storage 201 and display 202 (e.g. a monitor) shown in FIG. 4.

The method described above may further include analyzing the measured and calculated results using known statistical methods. In one embodiment, the development of the maximum response frequency and/or other results over time, for example, may document the training effect. Also, in the present or other applications, a confidence interval for ωr can be estimated which is smaller than the entire measurement interval, e.g. 15-120 Hz, but still large enough for the probability p that the maximum response frequency is located within said interval to be larger than a predetermined value, such as p>95%.

This may reduce the number of measurement points in the next measurement series, which may be recorded one or a few days later, for example, and stored in data storage 201 (FIG. 4). Data storage 201 may store several such measurement series recorded during a time period, e.g. one measurement series per day for 1-4 weeks, and/or only the particular frequency ωr within each measurement series which resulted in, for example, the maximum amplitude attenuation or phase shift.

Naturally, statistical analysis, trend analysis, etc. may be performed on one or more measured or calculated results, not only on the frequency as described above. The expression “calculating group value”, as used in the patent claims, is intended to include any known types of statistic analysis, trend analysis as well as other forms of analysis performed on one or more measured or calculated results, stored, for example, as measurement series of measurement points (ωi, Ri;) in data storage 201.

During use, it is not uncommon to encounter a patient with tissue or muscle that lacks a preferred amount of tension. One such instance is found in women that have given birth. The act of childbirth tends to cause the vaginal tissue to exhibit less viscoelasticity. The condition is also commonly found in female runners. In these cases, it may be beneficial to pre-tension the tissue or muscle prior to applying mechanotherapy or mechanotransduction therapy. The present invention is also able to determine an optimum pre-tension state of targeted tissue, even for patients that may not particularly have a past medical history that would indicate less viscoelasticity.

In the embodiments of the invention discussed above, a user or practitioner may adjust, for example by rotating, the apparatus 100 prior to insertion into the patient's vaginal opening. In another embodiment, a user or practitioner may adjust the apparatus 100 by rotating the housing after either before or after insertion into a patient's body cavity such as a vaginal or rectal opening.

Once inserted, a practitioner or user may cause pump 104 to activate and force the vibratory medium (a liquid or gas) to flow from a reservoir into the space 106. As the medium flows into the apparatus 100 it causes the outer casing 102 to expand. The pump 104 may be operated by depressing or activating a button or other type of switch on the controller 121. In other embodiments, the housing 101 may also be adjusted by expanding outwardly. The outer casing 102 or housing 101 can be adjusted until a desired amount of pre-tension is applied to the pelvic floor tissue. In still another embodiment of the invention, the housing 101 may pulse or provide some other sensory output detectable by the patient and/or device to indicate a particular frequency, treatment state (such as tissue fatigue), and the like. Any sensory output may be used to indicate any particular patient or device characteristic.

The sensors 150 in operative communication with the housing 101 read an amount of pre-tension applied to the vaginal or targeted tissue. As discussed above, the device is able to, either manually or automatically, move between a resting state and an expanded state to move the tissue to a pre-tension state. The device is able to determine an optimal pre-tension state of the tissue by various means, including but not limited to an amount of force applied to the tissue, a viscoelasticity of the tissue, an angle or angle of movement of the device during a contraction, impedance and the like. Other parameters may also be determined and should be considered to be within the spirit and scope of the invention. The cycle of determining the optimum pre-tension state can be run a number of times to obtain an optimal average of pre-tension.

The pre-tension reading is stored and may be used to compare against post treatment, and other collected pre-tension data. A difference in recorded pre-tension data may act as diagnostic tool that may be represented as an indication of effective treatment.

With the tissue or muscle in the pre-tension state, energy therapy, such as mechanotherapy or mechanotransduction therapy (described above), may be applied to the tissue or muscle. Another advantage of pre-tensioning is that it permits the therapy to be more effectively transmitted through the tissue cells to create a tissue regenerative environment.

As the patient or user continues therapy, the tissue or muscle will begin to become rehabilitated or more viscoelastic and the amount of pre-tensioning may be reduced accordingly.

The above should not be considered to be limited to the treatment of vaginal or rectal incontinence or other pelvic floor disorders but may be used for the treatment of any tissue, muscle or organ. For instance, it is within the spirit and scope of the invention to include an apparatus that is capable of being applied to or implanted in a patient's chest for mechanotherapy or mechanotransduction therapy of the chest tissue, muscles, lungs or heart.

In yet another embodiment of the invention, apparatus 100 may be reduced in size such that it may be insertable into a patient to apply energy treatment, such as mechanotherapy or mechanotransduction therapy, proximately or directly to an internal tissue, muscle or organ. For instance, it is possible to have an apparatus small enough to be inserted through a peripherally inserted central venous catheter to apply therapy directly to the heart.

In still another embodiment of the present invention, the outer casing 102 or housing 101 can be inserted into a vaginal opening and placed in a pre-tensioning state against a patient's tissue. The patient or user may then begin to perform Kegel exercises with or without any energy therapy. The patient or user may alternate a series of Kegal exercises with an increase in the pre-tensioning of the vaginal tissue. Even without the application of energy, the alternating of Kegal exercises with increasing and possibly decreasing the pre-tensioning of the vaginal tissue may provide effective treatment for some patients or users.

In still yet another embodiment, sensors of the device 100 are capable of detecting a characteristic of a tissue to be treated and then apply or focus energy to the tissue exhibiting the characteristic. For example, in a patient with a vaginal wall or tissue defect one or more sensors may detect a reduced contraction, force, tension or the like. The device 100 can then, either with the assistance of the patient or healthcare profession, or automatically, adjust to provide energy to the tissue exhibiting the characteristic.

The outer casing 102 may have a constant or varying thickness and may varying to accommodate a patient's or user's anatomy. The outer casing 102 may be also be removable from the housing 101 for replacement or cleaning.

In another embodiment of the invention, the pre-tensioning of the tissue may be accomplished by activating one or more electrodes or stimulators 34 coupled to or mounted in/on housing 101 or outer casing 102. The stimulators 34 can emit electrical stimuli that causes the proximate tissue to contract. The contraction of the tissue may be accomplished by a number of mechanisms, including causing the stiffening of tissue substrate. Once the proximate tissue is stimulated and pre-tensioned the mechanotherapy or mechanotransduction therapy or other energy therapy may be applied, which results in improved energy waves, such as vibrations being transmitted through the tissue. The stimulators 34 may be in operative communication with a power source disposed in or external to the housing 101.

The stimulators 34 may also be applied to the embodiment used for application of non-energy applied therapy. In this embodiment, a patient or user may expand the outer casing 102 to place the tissue in a pre-tension state. The patient or user may then begin performing Kegal exercises. The apparatus 100 or the user may select the stimulators 34 to apply energy to the pre-tensioned tissue. The stimulators may be pre-programed to apply energy at varying times or in response to another stimulus, such as a pressure reading by the sensors 150 caused by the Kegal exercises. The foregoing embodiment may also include the application of mechanotherapy or mechanotransduction therapy.

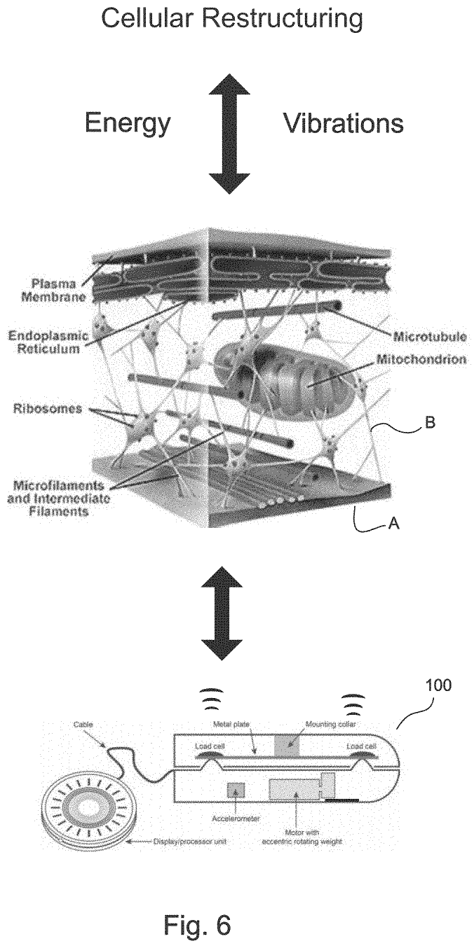

In another embodiment of the invention, as illustrated in FIG. 6, the mechanotherapy or mechanotransduction therapy emitted by the apparatus 100 of FIG. 1 is capable of producing enough vibratory energy to displace or deform a cellular membrane A by 5 to 15 nm. The deformation of the cellular membrane A disrupts microfilaments and intermediate filaments B which activates the cell to restructure and/or repair itself. This cellular restructure or repair improves the condition being treated, for instance, incontinence. A cellular deformation of greater than 15 nm and less then 5 nm is also contemplated herein and the foregoing should not be considered limiting.

The stimulation of the present invention also influences satellite cell activation, alignment, and diameter size, and to closely mimic tissue elasticity, structural organization, and force-generating capabilities of the native muscle or tissue.

During use, in one example embodiment, mechanical oscillations are superimposed on voluntary contractions with frequencies in the range of 25-50 Hz. During 5 minutes of daily exercise, for example, the women can perform 15 voluntary contractions within a duration of 5 seconds. Imposed on these contractions are mechanical oscillations with a frequency of, for example, 30 Hz. The amount of contractions will be 5 s×30 Hz×20 (i.e. 3000) deformations on the cytoskeleton and the extracellular matrix per training session, which equals 126,000 oscillations imposed on a voluntarily contracted pelvic floor during a 6-week training period. Using such simple calculations, the training load is 39 times higher with the superimposed mechanical oscillations than in usual PFMT training.

The disclosed mechanotherapy or mechanotransduction therapy may also be combined with stem cells to treat various medical conditions. In this embodiment, stem cells may be introduced into a location of a patient by use of a needle and syringe and then the energy therapy, such as mechanotherapy or mechanotransduction therapy disclosed herein, may be applied to stimulate the stem cells to differentiate into parts of the cell.

Various figures and descriptions disclose features and accessories. However, it must be noted that these features are merely illustrative in nature and may be placed in varying locations and under varying configurations and shapes, and still be consistent with the present invention. In addition, the shape and configuration for the various portions are also merely illustrative and can be altered without deviating from the spirit and scope of the present invention.

The present invention may be embodied in other specific forms without departing from the spirit or essential attributes thereof, and it is, therefore, desired that the present embodiment be considered in all respects as illustrative and not restrictive. Similarly, the above-described methods and techniques for forming the present invention are illustrative processes and are not intended to limit the methods of manufacturing/forming the present invention to those specifically defined herein.

What is claimed is:

1. An apparatus for rehabilitating a tissue, the apparatus comprising:
a housing having an interior and an orientation member, the housing being adapted to move with respect to the orientation member;
an oscillator operatively positioned in the interior of the housing and capable of generating and imparting oscillations on tissue to be rehabilitated; and
indicia positioned on the orientation member to identify a direction of the oscillations.

2. The apparatus of claim 1, further comprising:
an accelerometer operatively positioned in the interior of the housing, the accelerometer being adapted to read a change the tissue to be rehabilitated; and
a signal processor configured for receiving a signal from the accelerometer and determining a visco-elastic property of the tissue, wherein the signal processor reads a change in an amplitude signal generated by the accelerometer and the change in the amplitude signal correlates to a visco-elastic property of the tissue.

3. The apparatus of claim 1, wherein the housing further comprises an adjustable casing at least partially enclosing the housing, the casing being adapted to expand to pretension the tissue prior to the oscillator imparting oscillations on the cells.

4. The apparatus of claim 1, wherein the indicia comprises spaced apart marks.

5. The apparatus of claim 1, wherein the indicia comprises spaced apart numbers.

6. The apparatus of claim 1, further comprising housing indicia positioned on the housing, wherein the housing indicia and the indicia on the orientation member are alignable to indicate an orientation of oscillations.

7. The apparatus of claim 1, wherein the orientation member is rotatably positioned within a channel extending about a portion of the housing.

8. An apparatus for rehabilitating tissue, the apparatus comprising:
a housing having an interior and one or more housing indicia indicating a direction of treatment;
an oscillator operatively positioned in the interior of the housing and capable of generating oscillation treatments on the tissue to be rehabilitated; and
a controller in operative communication with the oscillator to control a characteristic of the oscillations.

9. The apparatus of claim 8, further comprising:
an accelerometer operatively positioned in the interior of the housing, the accelerometer being adapted to read a change in the tissue to be rehabilitated; and
a signal processor configured for receiving a signal from the accelerometer and determining a visco-elastic property of the tissue, wherein the signal processor reads a change in an amplitude signal generated by the accelerometer and the change in the amplitude signal correlates to a visco-elastic property of the tissue;
wherein pretensioning the tissue increases the delivery of therapy thereby increasing rehabilitation of the tissue.

10. The apparatus of claim 8, wherein the housing further comprises an adjustable casing at least partially enclosing the housing, the casing being adapted to expand to pretension the tissue prior to the oscillator imparting oscillations on the tissue.

11. The apparatus of claim 8, wherein the indicia comprises spaced apart marks.

12. The apparatus of claim 8, wherein the indicia comprises spaced apart numbers.

13. The apparatus of claim 1, further comprising an orientation member operatively coupled to the housing, the orientation member having orientation indicia that is alignable to the housing indica.

14. The apparatus of claim 13, wherein the orientation member is rotatable within a channel extending about a portion of the housing.

15. The apparatus of claim 8, wherein the controller includes a display to display a characteristic of the tissue being rehabilitated.

16. The apparatus of claim 15, wherein the controller includes a display to display at least one selected from the group of a visual display, an audio display, or a combination of a video display and an audio display.

17. A method for increasing tissue volume, the method comprising the steps of:
providing a housing having an interior containing an oscillator operatively disposed therein capable of generating an oscillation therapy;
providing an orientation member coupled to a portion of the housing, the orientation member having an indicia thereon that aids a user in knowing a direction of the oscillation therapy during use;
rotating the housing with respect to the indicia on the orientation member to align the housing to a desired direction of therapy; and
activating a controller operatively coupled to the oscillator to impart an oscillation therapy to the tissue;

18. The method of claim 17, further comprising the steps of:
providing an accelerometer able to measure an amplitude signal response from the tissue;
characterizing, with a signal processor, the volume of the cells of the tissue on an attenuation of the amplitude signal response to the imposed controlled oscillations; and
controlling the controlled oscillation from the oscillator with respect to the amplitude signal response from the floor measured by the accelerometer.

19. The method of claim 17, wherein the housing has one or more housing indicia that is alignable to the orientation indicia.

20. The method of claim 18, further comprising the step of expanding at least a portion of the housing pretension the tissue being treated.
